(19) United States
(12) Patent Application Publication
(10) Pub. No.: US 2026/0243411 A1
(43) Pub. Date: Aug. 20, 2026

(54) Push Rod Switch Lamp Holder

(71) Applicant: Rich Brand Industries Limited, Dongguan City (CN)

(72) Inventor: Liqiang Wei, Dongguan City (CN)

(21) Appl. No.: 19/055,795

(22) Filed: Feb. 18, 2025

(51) Int. Cl. F21V 19/00; F21V 23/04; F21V 23/06

(52) U.S. Cl. CPC F21V 19/0065; F21V 23/04; F21V 23/06

(57) ABSTRACT

A push rod switch lamp holder comprises a hook, an assisting hook and a stopping edge which are used together, to limit the position of the power cord from top and bottom. The cathode power connecting plate and anode power connecting plate are firmly assembled inside the side housing slot to firmly clamp the entering power cord, thereby ensuring safe use of electricity. The invention creatively adopts different ways of electric power conduction to realize the function of three-stage brightness control. Meanwhile, the push rod mechanism comprises a push rod, an elastic body and a middle guided connecting plate, thereby ensuring good power connection to the lighting component to be turned on or off.

### BACKGROUND OF THE INVENTION

The present invention relates to a push rod switch lamp holder, and more particularly to a push rod switch lamp holder that can ensure safe use of electricity by limiting the position of the power cord and firmly clamp the power cord to prevent disconnection.

### DESCRIPTION OF THE RELATED ART

Accordingly, the two electrodes of a conventional lamp holder are respectively connected with the two electrodes of a power cord, and the power cord is then connected to the commercial power supply. The main body of the lamp holder is installed with a switch in the form of a push rod, used to control the connection between the lamp holder and commercial power supply. Inside the lamp holder, there is a connecting part (such as a screw holder) to be connected with a lighting component (such as a light bulb). After the lighting component is screwed into the connecting part, the two electrodes of the lighting component are respectively connected with the two electrodes of the lamp holder. Thus, the push rod switch can be used to turn on or off the lighting component on the lamp holder. As this kind of lamp holder is configured with the push rod switch, it is called “push rod switch lamp holder”.

The structure of conventional push rod switch lamp holders has evolved over the time. In early times, the power cords are connected with the lamp holder by winding the peeled end on a tightening screw. Later, the connection by simply inserting the peeled tip of the power cord becomes more convenient. However, a shortcoming is discovered. As we know, the naked wire section of the wire tip after stripping has a smooth surface, and inside the lamp holder, a bent plate is configured to catch the naked wire end, pressing the naked wire section to prevent it from separation. Because the bent plate itself does not have a structure to reinforce the connection, although initially the naked section of the power cord tip can be connected with the bent plate, once a pulling force is applied, the power cord can be easily separated from the bent plate, causing troubles of examination and repair.

### SUMMARY OF THE INVENTION

In view of the above drawback, the present invention is further researched and improved. Therefore, it is a primary objective of the present invention to provide a push rod switch lamp holder that can ensure safe use of electricity by limiting the position of the power cord and firmly clamp the power cord to prevent disconnection when connecting the power cord with the lamp holder.

To achieve the above-mentioned objective, the present invention is to provide a push rod switch lamp holder, comprising a main casing, a covering plate, a cathode power connecting plate, an anode power connecting plate, a conduction plate, a push rod mechanism and a threaded collar, wherein a pair of erected hooks are defined upright inside a top surface of the main casing, an assisting hook is respectively formed on the front edges of the bottoms of the hooks, a stopping edge is configured on the top surface of the main casing corresponding to the fronts of the hooks, an inserting slot is provided near a side of each hook, the two sides of a bottom edge of the main casing are upward to respectively form a through slot communicating with the outside, the bottom surface of the main casing is inward to form a big housing slot located in a center and two side housing slots located on the left and right sides, the through slots of the two sides communicating with the big housing slot, the bottom surface of the main casing is inward to form a pair of engaging slots and a center of a top surface inside the big housing slot is concaved to form a positioning slot;

a raised enclosing slot is formed on a side of the covering plate facing the main casing, a through slot is formed on an internal side wall of the enclosing slot, a through slot is configured on the covering plate located within a range of the enclosing slot and a big housing hole and a connecting hole are configured correspondingly on the covering plate;

the cathode power connecting plate from top to bottom is firstly provided with a clamping section, a front end is concaved to form a concave contacting slot, a rear end is bent downward to upright form a first base section, two clamping hooks are convexly configured on the two sides of the first base section, the bottom end of the base section is bent to upright form a second base section and then bent again to form a horizontal connecting surface having a connecting hole;

the anode power connecting plate from top to bottom is firstly provided with a clamping section, a front end is concaved to form a concave contacting slot, rear end is bent downward to upright form an abutting plate, two clamping hooks are convexly configured on the two side of the abutting plate and one side of the abutting plate is extending backward to form a guided connecting plate;

the conductive plate from top to bottom is firstly provided with an inserting plate, a lower end is inclined downward to form a conductive piece and one side of the inserting plate is bent inward and is extending in a reserve direction to form a guided connecting plate;

the push rod mechanism comprises a push rod, an elastic body and a middle guided connecting plate, the two sides of the push rod are respectively provided with a horizontal bar, the inner ends of the horizontal bars on face upward to be connect to form a bridge, a bottom surface of the bridge is provided with a supporting convex block, a stopping bar is configured respectively on the two ends of the bridge, a space is formed between the two stopping bars, the inner ends of the horizontal bars face downward to form a leg respectively, and the elastic body is capable of elastic expansion or contraction, the middle guided connecting plate has an abutting bar located on the upper side, one side of the abutting bar extends downward to form a connecting bar, the bottom end of the connecting bar extends in the reserve direction to form a guided connecting bar, a supporting block is configured on the top surface of the guided connecting bar in an arched and raised form, the abutting bar is hung on the bridge, and then one end of the elastic body is supported by the supporting block of the guided connecting bar and the other end is placed into the bottom surface of the bridge to be supported by the supporting convex block;

the threaded collar is an electrical conducting material, a ring wall is configured with a ring circle, an open slot is configured on a top surface and a connecting hole is respectively configured on the two sides of the open slot; and

while assembly, the clamping section, the first base section and the second base section of the cathode power connecting plate are penetrated and fitted into one of the side housing slots of the main casing, thereby enabling the concave contacting slot of the clamping section to be positioned inside one of the inserting slots, and meanwhile the connecting section of the cathode power connecting plate abuts against a block of the main case, and the connecting hole of the connecting section is aligned to the connecting slot inside the block; the anode power connecting plate is fit into the other side housing slot to enable the abutting plate of the anode power connecting plate to be inserted into a thin slot inside the side housing slot and enable the concave contacting slot of the clamping section to be positioned inside the other inserting slot, and the guided connecting plate of the anode power connecting plate is extending into one side of the interior of the big housing slot; the conductive plate is placed from the other side of the big housing slot to enable the inserting plate of the conductive plate to be inserted into the thin slot inside the big housing slot and enable the conductive piece of the conductive plate to extend out from the interior of the big housing slot, the guided connecting plate of the conductive plate extends to rest inside the big housing slot in a position relative to the guided connecting plate of the anode power connecting plate; the push rod mechanism is fit into the big housing slot to enable the horizontal bars on the two sides to extend out of the through slot, the abutting bar of the middle guided connecting plate is pressed into the positioning slot of the main casing to be positioned softly, and meanwhile the middle guided connecting plate is located between the guided connecting plate of the anode power connecting plate and the guided connecting plate of the conductive plate; the covering plate is further placed close to the main casing to enable the enclosing slot of the covering plate to enter into a space of the main casing and enable the conductive piece of the conductive plate to be inserted into the enclosing slot of the covering plate and then extended out of the through slot of the covering plate to be placed in along a slope, and meanwhile the big housing hole and the connecting hole of the covering plate are respectively aligned to the connecting slot of the main casing, the block of the main casing is put into the big housing hole, and the guided connecting plate of the conductive plate extends out from the through slot of the enclosing slot; and, the threaded collar is placed on the bottom surface of the covering plate to enable the raised block of the covering plate to be pressed into the open slot of the threaded collar, and meanwhile the connecting hole of the threaded collar is aligned and secured with the big housing hole and the connecting hole of the covering plate.

According to the above-mentioned push rod switch lamp holder, wherein a positioning slot is configured on the external side wall of the enclosing slot and the positioning slot is pressed by a block inside the main casing to be positioned when the covering plate is moving close to the main casing

According to the above-mentioned push rod switch lamp holder, wherein a positioning column is configured vertically on the inner side of the enclosing slot at an adjacent position, and one leg of the push rod mechanism is abutted and positioned by the positioning column.

### BRIEF DESCRIPTION OF THE DRAWINGS

FIG. 1 is a perspective view of the present invention.

FIG. 2 is an exploded perspective view 1 of the present invention.

FIG. 3 is an exploded perspective view 2 of the present invention.

FIG. 4 is a top view of the main housing of the present invention when the power cable is connected to power supply.

FIG. 5 is a top view of the present invention after assembly of the cathode power connecting plate, anode power connecting plate, conductive plate, and push rod mechanism.

FIG. 6 is a sectional side view of the present invention after assembly, power connection, and screw connection of the bulb.

FIG. 7 is a sectional front view of the present invention after assembly, power connection, and screw connection of the bulb.

FIG. 8 is a sectional side view of the present invention when the push rod is pushed for the bulb to be connected to the power supply.

FIG. 9 is a top view of the present invention when the push rod is pushed for the bulb to be connected to the power supply.

### DETAILED DESCRIPTION OF EMBODIMENTS OF THE INVENTION

For better understanding of the technical means to achieve the above object and the effects of the present invention to be accomplished, detailed descriptions are provided below with respect to the following preferred embodiment and with reference to the accompanying figures.

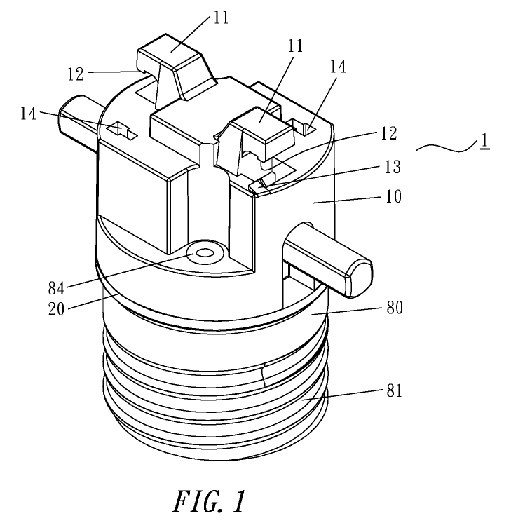

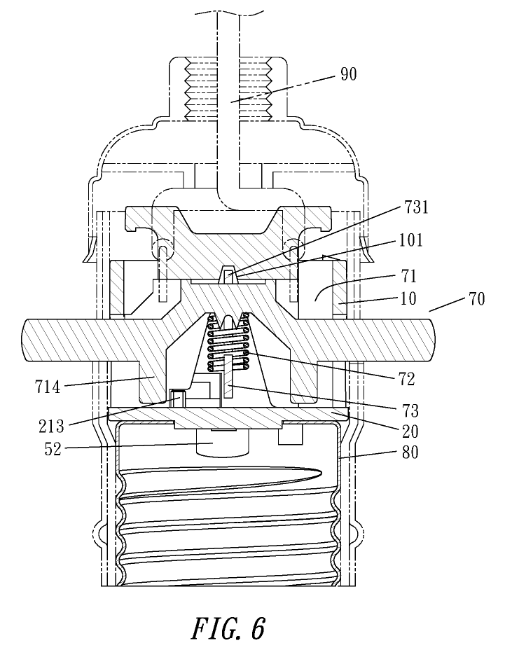

With reference to FIGS. 1 to 5, the present invention is a push rod switch lamp holder 1, comprising a main housing 10, a covering plate 20, a cathode power connecting plate 30, an anode power connecting plate 40, a conductive plate 50, a push rod mechanism 70 and a threaded collar 80, wherein, the main casing 10 and the covering plate 20 are made of non-conducting materials, the push rod mechanism 60 is partially conductive, the cathode power connecting plate 30, the anode power connecting plate 40, the conductive plate 50, and the threaded collar 80 are all made of electrical conducting materials. On the top surface of the main casing 10, a set of hooks 11 are configured in a standing form. The bodies of the hooks 11 face downward, and the bodies of the two hooks 11 are back to back. An assisting hook 12 is formed on the front edge under the hook body. On the top surface of the main casing 10, a stopping edge 13 is configured in relation to the front of the hook 11. An insertion slot 14 is configured beside the hook 11. On the bottom edge of the main casing 10, an upward through slot 15 is configured respectively on the two sides, communicating with the outside. On the bottom surface of the main casing 10, a big housing slot 16 located in the center and side housing slots 17 located on the left and right sides are configured. The through slots 15 on the two sides are communicated with the big housing slot 16. On the bottom surface of the main casing 10, a set of inward connecting slots 18 are configured, wherein one connecting slot 18 is enclosed by a raised block 19. Further, a positioning slot 101 is configured at the center of the internal top surface of the big housing slot 16 in a concave form (as shown in FIG. 6).

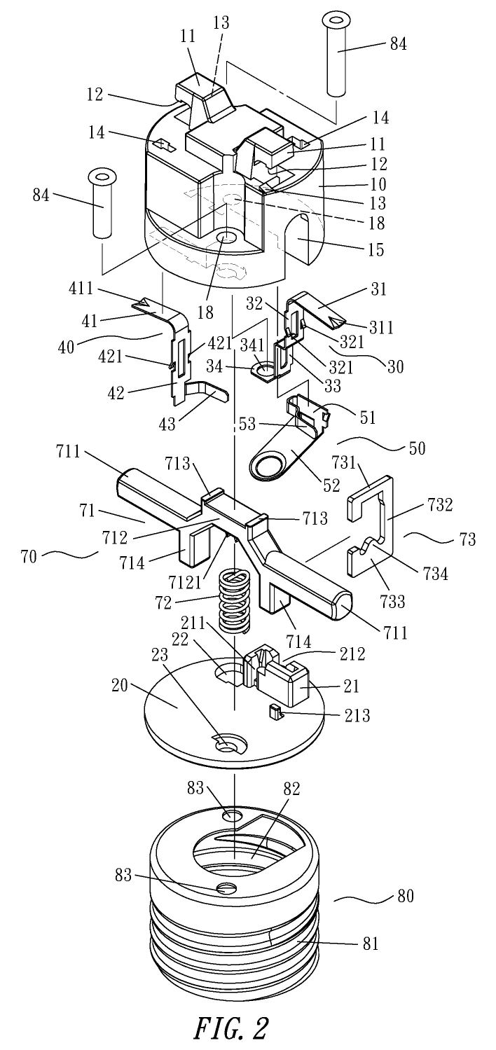

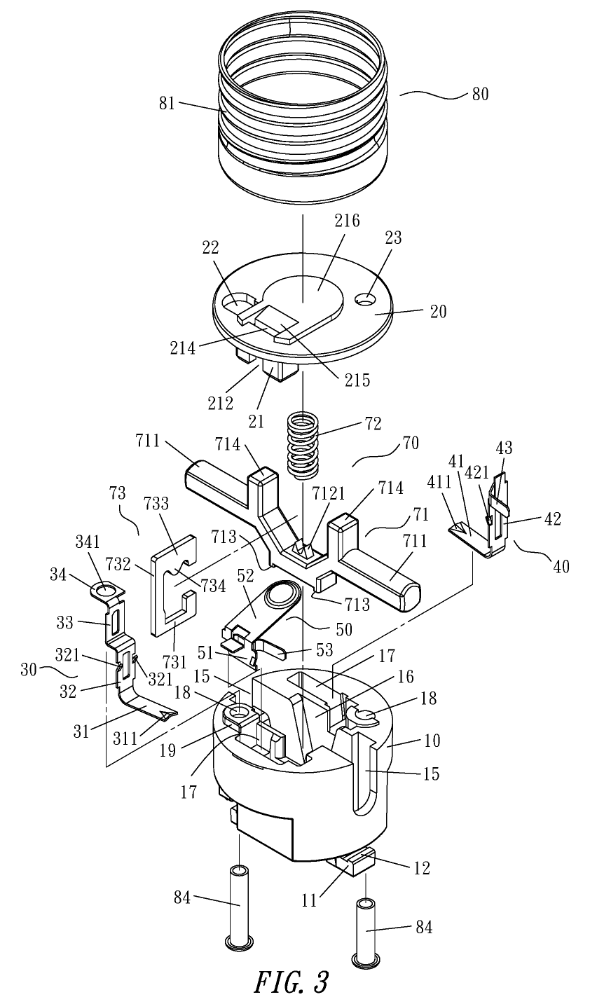

The covering plate 20 is in the form of a round plate, with its outer diameter corresponding to that of the bottom edge of the main casing 10 for covering. On the surface of the covering plate 20, a protruding enclosing slot 21 is formed on the side facing the main housing 10, deflecting to one side. A through slot 211 is configured on the internal side wall of the enclosing slot 21. A positioning slot 212 is configured on the external side wall. A positioning column 213 is vertically configured on the inner side adjacent to the side wall. As shown in FIG. 2, within the range enclosed by the enclosing slot 21, a through slot 214 is configured on the covering plate 20. The side of the through slot 214 facing the threaded collar 80 to be mentioned later is connected with a slope 215. The two sides of the slope 215 are formed as thin raised blocks 216. The raised blocks 216 form a ring shape toward the center. As shown in FIG. 3, on the covering plate 20 and adjacent to the enclosing slot 21, a big housing hole 22 is configured, and a connecting hole 23 is configured at the corresponding position.

The cathode power connecting plate 30 is made by bending and die-pressing a plate. From top to bottom, firstly there is a clamping section 31 inclining slightly downward. On the tip of its front end, a concave contacting slot 311 is configured. The rear end is bent downward and then goes vertical to form a first base section 32. Its two sides are configured with clamping hooks 321 in a protruding form. The bottom end of the base section 32 is bent twice and then goes vertical to form a second base section 33 and then bends again to form a horizontal connecting surface 34, on which a connecting hole 341 is configured.

The anode power connecting plate 40 is made by bending and die-cutting a plate. From top to bottom, firstly there is a clamping section 41 slightly inclining downward. On the tip of its front end, a concave contacting slot 411 is configured. Its rear end is bent downward to form a vertical abutting plate 42, with clamping hooks 421 configured on its two sides in a convex form. One side of the abutting plate 42 extends downward to form a guided connecting plate 43.

The conductive plate 50 is made by bending and die-pressing a plate. From top to bottom, firstly there is a vertical inserting plate 51. Its lower end is inclined downward to form a conductive piece 52. One side of the inserting plate 51 is bent inward and extends in the opposite direction to form a guided connecting plate 53.

The push rod mechanism 70 is composed of a push rod 71, an elastic body 72, and a middle guided connecting plate 73. The push rod 71 is of a non-conducting material. The push rod 71 is of an electrical conducting material. The conductivity of the elastic body 72 is not limited. The two sides of the push rod 71 are respectively a horizontal bar 711. The inner ends of the horizontal bar 711 on two sides tilt upward and are connected to form a bridge 712. On the bottom surface of the bridge 712, a supporting convex block 7121 is configured. A stopping bar 713 is configured respectively on the two ends of the bridge 712. Between the two stopping bars 713, a space is formed. The inner ends of the horizontal bar 711 on two sides both extend downward to form a leg 714. The elastic body 72 is capable of elastic expansion or contraction and preferably a straight spring. The middle guided connecting plate 73 is formed roughly in the shape of a “C”, and is divided into an abutting bar 731 located on the upper side, a connecting bar 732 extending downward from one side of the abutting bar 731, and a guided connecting bar 733 extending in the opposite direction from the bottom end of the connecting bar 732. A supporting block 734 is configured on the top surface of the guided connecting bar 733 in an arched and raised form. During the assembly, firstly hang the abutting bar 731 of the middle guided connecting plate 73 on the bridge 712 of the middle guided connecting plate 73. Then, support one end of the elastic body 72 with the supporting block 734 of the guided connecting bar 733, and place the other end onto the bottom surface of the bridge 712 of the middle guided connecting plate 73, to be supported by the supporting convex block 7121. Thus, the upper and lower ends of the middle guided connecting plate 73 are respectively supported by the bridge 712 and the elastic body 72. The upper and lower ends of the elastic body 72 are respectively pressed by the supporting block 734 and the supporting convex block 7121. Thus, the push rod 71, the elastic body 72, and the middle guided connecting plate 73 are balanced and assembled to form the push rod mechanism 70.

On the ring wall of the threaded collar 80, thread rings 81 are configured. On the top surface, an open slot 82 is configured. The two sides of the open slot 82 are respectively configured with a connecting hole 83.

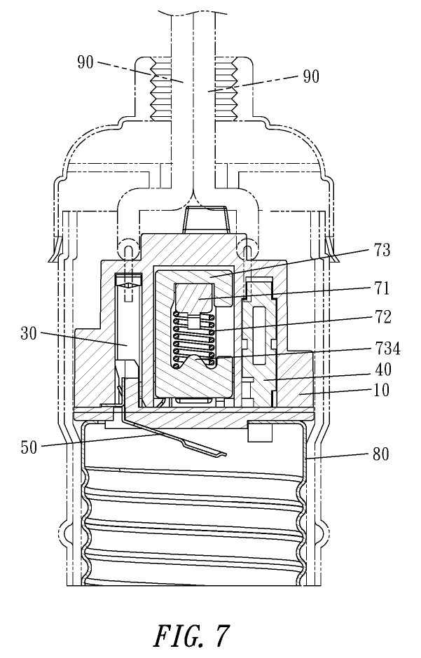

The assembly of the push rod switch lamp holder 1 is depicted in FIGS. 6 and 7. The clamping section 31, first base section 32 and second base section 33 of the cathode power connecting plate 30 are fit into the housing slot 17 of the main casing 10 on one side, until the concave contacting slot 311 of the clamping section 31 is located inside one of the insertion slots 14. The connecting section 34 abuts against the block 19, and the connecting hole 341 is aligned to the connecting slot 18. Then, the anode power connecting plate 40 is fit into the housing slot 17 on the other side, until the abutting plate 42 of the anode power connecting plate 40 is inserted into and clamped by the thin slot extending from the side housing slot 17. Thus, the concave contacting slot 411 of the clamping section 41 is located inside the other insertion slot 14, and the guided connecting plate 43 of the anode power connecting plate 40 is extended into the big housing slot 16 on one side.

Then, the conductive plate 50 is placed from the other side of the big housing slot 16, until the inserting plate 51 of the conductive plate 50 is inserted into and clamped by the thin slot extending from the big housing slot 16, so that the conductive piece 52 of the current conduction plate 50 extends out from inside the big housing slot 16, while the guided connecting plate 53 of the conductive plate 50 is extended and suspended inside the big housing slot 16, in a position relative to the guided connecting plate 43 of the anode power connecting plate 40 with a space in between. Then, the push rod mechanism 70 is fit into the big housing slot 16, so that the horizontal bars 711 on the two sides extend out of the through slot 15. As shown in FIGS. 5 to 7, the abutting bar 731 of the middle guided connecting plate 73 is pressed into the positioning slot 101 of the main housing 10 and be fixed. As the horizontal bar 711 and the middle guided connecting plate 73 are limited by the internal walls of the big housing slot 16 on two sides, the push rod mechanism 70 stands inside the big housing slot 16. Moreover, at this point, neither the middle guided connecting plate 73 nor the guided connecting plate 43 of the anode power connecting plate 40 are in contact with the guided connecting plate 53 of the conductive plate 50, there is no electrical conduction between the guided connecting plates 43, 53.

Then, the covering plate 20 is placed close to the main casing 10, until the enclosing slot 21 of the covering plate 20 enters the space of the main casing 10. A block inside the main casing 10 presses into the positioning slot 212 of the enclosing slot 21 and be positioned, and one leg 714 of the push rod mechanism 70 is resisted by the positioning column 213 of the covering plate 20 and be positioned (see FIG. 6). The conductive piece 52 of the conductive plate 50 is inserted from the enclosing slot 21 of the covering plate 20, extended out of the through slot 214, and then placed along the slope 215 in a tilted direction, so that the big housing hole 22 of the covering plate 20 is aligned both to the connecting hole 23 and the connecting slot 18 of the main casing 10. The big housing hole 22 further provides space for the block 19 to press in and be positioned. During the process, the guided connecting plate 53 of the conductive plate 50 extends out of the through slot 211 of the enclosing slot 21. Then, the threaded collar 80 is placed on the bottom surface of the covering plate 20, and adjusted until the raised block 216 of the covering plate 20 is pressed into the open slot 82 of the threaded collar 80 and is positioned. The connecting hole 83 of the threaded collar 80 is aligned both to big housing hole 22 and connecting hole 23 of the covering plate 20. Now, a connecting piece 84 can go through the connecting slot 18 of the main casing 10, the big housing hole 22 and connecting hole 23 of the covering plate 20 and the connecting hole 83 of the threaded collar 80 for fixation. The assembly of the push rod switch lamp holder 1 is completed. Outside the push rod switch lamp holder 1, an insulating cap and an insulating outer wall is assembled. As this is not the characteristics of the present invention, it is not detailed herein.

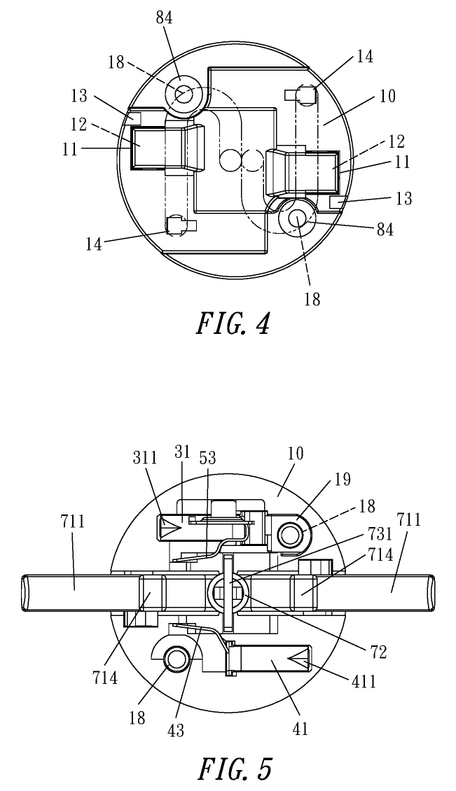

Before actual use of the present invention push rod switch lamp holder 1, the electric connection of the power cable must be firstly completed. As shown in FIGS. 4, 6 and 7, the end of the power cable 90 connected from commercial power supply must be stripped for a small section to form a naked section. After putting in the naked section of the power cable 90 through an insulating cap from the topside, the two wires of the power cable 50 are separated and respectively winded and pressed under the hook 11 of the main casing 10. The wires of the power cable 90 are limited between the assisting hook 12 and the stopping edge 13, i.e., the assisting hook 12 and the stopping edge 13 work together with the hook 11 to clamp the power cable 90 passing through, and limit its position to prevent it from separation. Then, the naked section of the power cable 90 is inserted downward along the corresponding insertion slot 14. The naked sections of the two wires of the power cable 90 respectively reach the clamping section 31 of the cathode power connecting plate 30 and the clamping section 41 of the anode power connecting plate 40. A force is applied to insert the naked section of the power cable 90 further into the corresponding insertion slot 14. The naked section of the power cable 90 respectively pushes apart the clamping sections 31, 41 and goes further in. Immediately, the recovering force of the clamping section 31, 41 enables the concave contacting slot 311, 411 to strongly press the naked section of the power cable 90. The power connection of the push rod switch lamp holder 1 is completed.

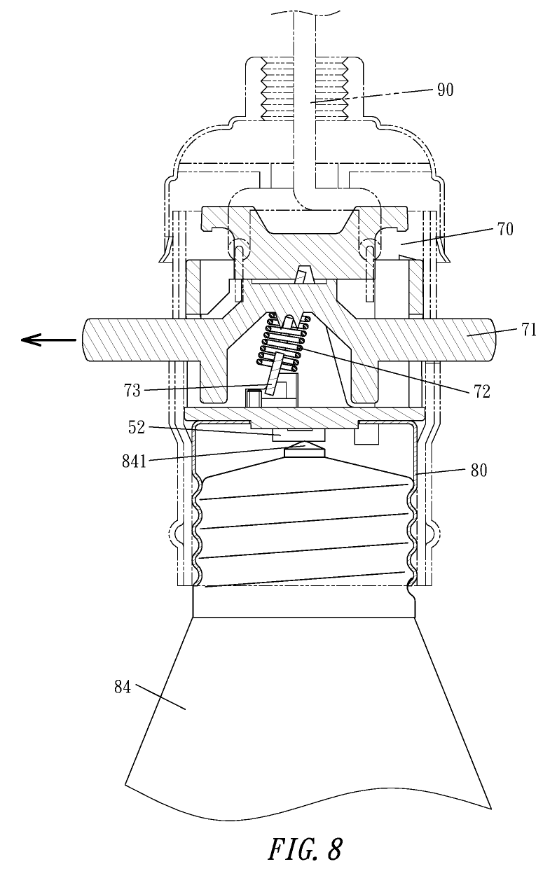

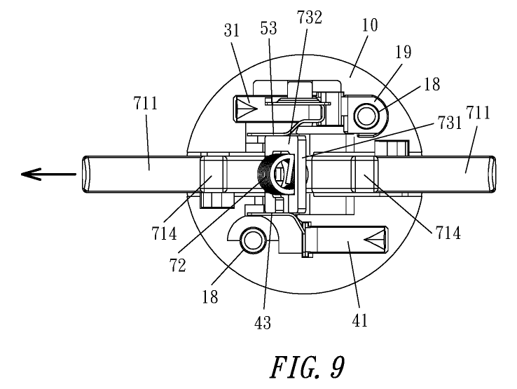

After power connection, the push rod switch lamp holder 1 of the present invention can be connected with a lighting component. As shown in FIG. 8, a bulb 84 is provided, having a screw head on its top. On the top end of the screw head, there is an electrical conduction point 841. When the screw head is screwed into the threaded collar 80, the screw head is electrically conducted through the threaded collar 80, i.e., electrically connected to the cathode power connecting plate 30. When the screw head is screwed to the final point, the electrical conduction point 841 is conducted to the conductive piece 52 of the conductive plate 50. When the push rod 71 is pushed toward one side (left side in FIG. 8, FIG. 9), as the abutting bar 731 of the middle guided connecting plate 73 is supported and softly fixed by the positioning slot 101, the abutting bar 731 can only have very limited movement, but the connecting bar 732 and the guided connecting bar 733 are driven by the push rod 71 to have deflection displacement. As a result, the guided connecting bar 733 is moved to a position conducted both to the guided connecting plate 43 of the anode electricity connecting plate 40 and the guided connecting plate 53 of the current conduction plate 50. Thus, the power from the anode electricity connecting plate 40 can be conducted to the light circuit inside the bulb 84 via the middle guided connecting plate 73, the current conduction plate 50, and the electrical conduction point 841. On the contrary, when the bulb 84 is lighting, if the push rod 71 is pushed toward the other side to return to the position shown in FIGS. 5 and 6, the middle guided connecting plate 73 is separated from the guided connecting plate 43 and the guided connecting plate 53, and the bulb 84 is immediately turned off.

As described above, the present invention mainly features the combined use of the hook 11, the assisting hook 12, and the stopping edge 13 to limit the passing power cable 90 from upside and downside to fix the cable. The invention creatively uses the cathode power connecting plate 30 and the anode power connecting plate 40 that are stably assembled in the side housing slot 17 of the main casing 10, to stably clamp the power cable 90 inserted in through the insertion slot 14. In this way, the power cable 90 is not only positioned, but also strongly clamped, so that the power cable 90 is not separated from the cathode electricity connecting plate 30 and the anode electricity connecting plate 40. This can ensure safe use of electricity.

In summary, the present invention can truly achieve the anticipated functions and objects, and based on the above detailed descriptions, the invention can be implemented by those skilled in the art. However, the above embodiment is provided only for the purpose of describing the present invention. All equivalent structural variations shall be covered by the scope of the present invention.

What is claimed is:

1. A push rod switch lamp holder, comprising:
a main casing, a covering plate, a cathode power connecting plate, an anode power connecting plate, a conduction plate, a push rod mechanism and a threaded collar, wherein a pair of erected hooks are defined upright inside a top surface of the main casing, an assisting hook is respectively formed on the front edges of the bottoms of the hooks, a stopping edge is configured on the top surface of the main casing corresponding to the fronts of the hooks, an inserting slot is provided near a side of each hook, the two sides of a bottom edge of the main casing are upward to respectively form a through slot communicating with the outside, the bottom surface of the main casing is inward to form a big housing slot located in a center and two side housing slots located on the left and right sides, the through slots of the two sides communicating with the big housing slot, the bottom surface of the main casing is inward to form a pair of engaging slots and a center of a top surface inside the big housing slot is concaved to form a positioning slot;
a raised enclosing slot is formed on a side of the covering plate facing the main casing, a through slot is formed on an internal side wall of the enclosing slot, a through slot is configured on the covering plate located within a range of the enclosing slot and a big housing hole and a connecting hole are configured correspondingly on the covering plate;
the cathode power connecting plate from top to bottom is firstly provided with a clamping section, a front end is concaved to form a concave contacting slot, a rear end is bent downward to upright form a first base section, two clamping hooks are convexly configured on the two sides of the first base section, the bottom end of the base section is bent to upright form a second base section and then bent again to form a horizontal connecting surface having a connecting hole;
the anode power connecting plate from top to bottom is firstly provided with a clamping section, a front end is concaved to form a concave contacting slot, rear end is bent downward to upright form an abutting plate, two clamping hooks are convexly configured on the two side of the abutting plate and one side of the abutting plate is extending backward to form a guided connecting plate;
the conductive plate from top to bottom is firstly provided with an inserting plate, a lower end is inclined downward to form a conductive piece and one side of the inserting plate is bent inward and is extending in a reserve direction to form a guided connecting plate;
the push rod mechanism comprises a push rod, an elastic body and a middle guided connecting plate, the two sides of the push rod are respectively provided with a horizontal bar, the inner ends of the horizontal bars on face upward to be connect to form a bridge, a bottom surface of the bridge is provided with a supporting convex block, a stopping bar is configured respectively on the two ends of the bridge, a space is formed between the two stopping bars, the inner ends of the horizontal bars face downward to form a leg respectively, and the elastic body is capable of elastic expansion or contraction, the middle guided connecting plate has an abutting bar located on the upper side, one side of the abutting bar extends downward to form a connecting bar, the bottom end of the connecting bar extends in the reserve direction to form a guided connecting bar, a supporting block is configured on the top surface of the guided connecting bar in an arched and raised form, the abutting bar is hung on the bridge, and then one end of the elastic body is supported by the supporting block of the guided connecting bar and the other end is placed into the bottom surface of the bridge to be supported by the supporting convex block;
the threaded collar is an electrical conducting material, a ring wall is configured with a ring circle, an open slot is configured on a top surface and a connecting hole is respectively configured on the two sides of the open slot; and
while assembly, the clamping section, the first base section and the second base section of the cathode power connecting plate are penetrated and fitted into one of the side housing slots of the main casing, thereby enabling the concave contacting slot of the clamping section to be positioned inside one of the inserting slots, and meanwhile the connecting section of the cathode power connecting plate abuts against a block of the main case, and the connecting hole of the connecting section is aligned to the connecting slot inside the block;
the anode power connecting plate is fit into the other side housing slot to enable the abutting plate of the anode power connecting plate to be inserted into a thin slot inside the side housing slot and enable the concave contacting slot of the clamping section to be positioned inside the other inserting slot, and the guided connecting plate of the anode power connecting plate is extending into one side of the interior of the big housing slot;
the conductive plate is placed from the other side of the big housing slot to enable the inserting plate of the conductive plate to be inserted into the thin slot inside the big housing slot and enable the conductive piece of the conductive plate to extend out from the interior of the big housing slot, the guided connecting plate of the conductive plate extends to rest inside the big housing slot in a position relative to the guided connecting plate of the anode power connecting plate;
the push rod mechanism is fit into the big housing slot to enable the horizontal bars on the two sides to extend out of the through slot, the abutting bar of the middle guided connecting plate is pressed into the positioning slot of the main casing to be positioned softly, and meanwhile the middle guided connecting plate is located between the guided connecting plate of the anode power connecting plate and the guided connecting plate of the conductive plate;
the covering plate is further placed close to the main casing to enable the enclosing slot of the covering plate to enter into a space of the main casing and enable the conductive piece of the conductive plate to be inserted into the enclosing slot of the covering plate and then extended out of the through slot of the covering plate to be placed in along a slope, and meanwhile the big housing hole and the connecting hole of the covering plate are respectively aligned to the connecting slot of the main casing, the block of the main casing is put into the big housing hole, and the guided connecting plate of the conductive plate extends out from the through slot of the enclosing slot; and
the threaded collar is placed on the bottom surface of the covering plate to enable the raised block of the covering plate to be pressed into the open slot of the threaded collar, and meanwhile the connecting hole of the threaded collar is aligned and secured with the big housing hole and the connecting hole of the covering plate.

2. The push rod switch lamp holder of claim 1, wherein a positioning slot is
configured on the external side wall of the enclosing slot and the positioning slot is pressed by a block inside the main casing to be positioned when the covering plate is moving close to the main casing.

3. The push rod switch lamp holder of claim 1, wherein a positioning column is
configured vertically on the inner side of the enclosing slot at an adjacent position, and one leg of the push rod mechanism is abutted and positioned by the positioning column.
